(19) United States
(12) Patent Application Publication
(10) Pub. No.: US 2023/0151309 A1
(43) Pub. Date: May 18, 2023

(54) PLANT-BASED HYDROALCOHOLIC FORMULATIONS FOR IMPROVING LIVER HEALTH

(71) Applicants: Amy Holmwood, Park City, UT (US); Nathalie Chevreau, Salt Lake City, UT (US)

(72) Inventors: Amy Holmwood, Park City, UT (US); Nathalie Chevreau, Salt Lake City, UT (US)

(21) Appl. No.: 17/988,746

(22) Filed: Nov. 16, 2022

Related U.S. Application Data
(60) Provisional application No. 63/279,917, filed on Nov. 16, 2021.
(60) Provisional application No. 63/282,113, filed on Nov. 22, 2021.

(51) Int. Cl. C12G 3/055

(52) U.S. Cl. CPC C12G 3/055

(57) ABSTRACT

The invention features a composition comprising a botanical rich alcoholic beverage that retains its sensory qualities and health benefits stably over time in storage. Health effects of the beverage protect the liver from the effects of alcohol induced oxidative stress. The beverage product remains stable under normal storage conditions for at least 6 months, e.g., in excess of 2 years. Dried herbs/plants/fruits have been historically consumed based on the belief and often supportive scientific evidence that such botanicals protect from injurious exposures and contribute generally to health maintenance. A composition of the invention features key phytonutrients such as epigallocatechin gallate (EGCG) in an alcoholic beverage stabilized to produce an alcoholic beverage that protects the liver against alcohol damage and presents with its unique taste and color.

Priority is claimed to provisional applications 63/279,917 and 63/282,113.

The present invention features a composition comprising a botanical rich alcoholic beverage that retains its sensory qualities and healthy benefits stably over time in storage. Dried herbs/plants/fruits have been historically consumed based on the belief and often supportive scientific evidence that such botanicals protect from injurious exposures and contribute generally to health maintenance. A composition of the invention features key phytonutrients such as epigallocatechin gallate (EGCG) in an alcoholic beverage stabilized to produce an alcoholic beverage that protects the liver against alcohol damage and presents with its unique taste and color. When applied to liver cells in vitro, this composition protects the liver from the harmful effects of alcohol induced oxidative stress.

The want or need for limiting, minimizing and/or mitigating deleterious effects of alcohol and its metabolites on the body, especially hepatic cells is recognized in the arts relating to health and alcoholic beverages.

In addition to medical and popular literature, for example:
Ikonte (U.S. Pat. No. 7,718,201) teaches a composition made of various botanical extracts including artichoke extract that may be in the form of pill, tablet, powdered product reconstituted with water. The composition is given to a group of experimental animals daily for 30 days. Another group is used as the control. Then a single dose of alcohol is given to both group and the animals are sacrificed 16 hours after consuming the alcohol. Again, the protective agent and the stressor are not applied at the same time or concurrently.
Kim (US 2019/0091276) teaches a composition that contains green tea extract that protects cells from oxidative stress. In this case one of the 2 groups of experimental animals are given the composition for 4 weeks. Both groups are given a toxin (scopolamine) to create damage to brain neurons. The animals are then sacrificed, and the damage compared between the 2 groups.
Fisher (U.S. Pat. No. 9,132,162 B2) teaches a composition containing muscadine pomace (skin, seed and pulp, after the juice has been removed) to which resveratrol from Japanese knotweed and other polyphenols have been added for anti-aging and protection from oxidative stress. It is well known that red grapes (Vitis vinifera) contain several bioactive polyphenolic compounds such as polymeric anthocyanidins, anthocyanins, tannins and some stilbene (resveratrol). Muscadine grapes that are native to the Southeastern part of the US contain very little resveratrol but measurable levels of catechins, ellagic acid, and ellagitannins that are either in trace amounts or absent in red grapes. He teaches that he uses acidulants to balance microbial inhibition and optimal taste when the composition is used in a beverage. He states that the acidulant can serve as an antioxidant to stabilize beverage components but nowhere does he specifically talk about protecting the catechins or other components to prevent their decomposition.

### DETAILED DESCRIPTION

### Problem to be Solved

Consumption of ethanol is associated with liver damage and health issues. The idea of protecting liver damage from the consumption of alcohol is not new. Numerous herbal extracts have been tested to alleviate the damage that alcohol inflicts to the liver, mostly in cell culture and animal studies.

It is well known that excessive use of alcohol can lead to irreversible liver damage Ethanol toxicity has been well studied. It is also known that activation of Nrf2 signaling in the intestinal mucosa and liver activates the expression of protective genes (Aleksunes and Manautou, 2007). Therefore, compounds that activate Nrf2 gene expression may also provide protection from alcohol induced damage. Several botanicals as well as vitamin supplements have been described as protective to the liver. Vodka infused with botanicals may reduce ethanol induced liver toxicity, Therefore, the primary purpose of the IONTOX study discussed in this application is to demonstrate protection and to define the absorption and delivery of the test botanicals to the liver.

The present disclosure relates to a composition that results from the blending of 95% gluten free ethanol that has been 3 times distilled. Purified water is added to bring the percentage of alcohol to 40% and yields a pH between 7 and 8.5.

### BRIEF DESCRIPTION OF THE DRAWINGS

FIG. 1 shows Viability of Liver Cells measured at several EtOH concentrations. Maximum Tolerated Dose is indicated as the % EtOH where viability as assayed using ATP levels diminished to below 50%.

FIG. 2 shows results obtained In HepG2 liver cells. Reactive Oxygen Species were measured using the DCFDA/H2DCFDA Cellular ROS Assay Kit from Abeam.

FIG. 3 depicts a two-compartment HuDMOP system model.

FIG. 4 and FIG. 5 show viability results obtained following exposure of Intestinal tissue to embodiments of the present invention.

FIG. 6 presents a chromatogram of EGCG standard at 100 ng/ml.

FIG. 7 presents a chromatogram of EGCG detected in Batch 1 (10% EtOH) after traversing through the intestinal tissue at 2 hours.

FIG. 8. shows the time course of EGCG movement through the intestinal membrane.

FIG. 9 shows the time course of EGCG appearance in the liver compartment.

FIG. 10 shows the time course of EGCG collected in the perfusate following passage through the liver compartment.

FIG. 11 compares expression levels of the NADPH Quinone Dehydrogenase 1 gene under 4 test conditions.

FIG. 12 compares expression levels of the Heme oxygenase 1 gene under 4 test conditions.

FIG. 13 compares expression levels of the Glutathione reductase under 4 test conditions.

### DETAILED DESCRIPTION OF THE INVENTION

Muscadine grapes (Vitis rotundifolia from the family of Vitaceae) are crushed in a press to extract the juice. The juice is then filtered to obtain a 68% Brix containing juice measured by refractometry. The juice is diluted and further filtered through a 0.45-micron Koch membrane to further remove sediments/turbidity/cloudiness, to bring the level of sugar down to a level approaching or about 12 (preferably in a range about 12-13.5% Brix), and to feature an acidity pH between about 3 and 4. The final color of the juice is bronze-gold.

The filtered muscadine juice is added to a water and ethyl alcohol mixture (preferably with a starting pH in a range between about 6.5 to 7.8) under constant agitation at a temperature temperature between about 20 and 25° C. until the pH falls below 4.65 to create a beverage starter media where catechins and other phytonutrients will not auto-oxidize thus will remain stable overtime.

Leaves of green tea (Camellia sinensis) are extracted in a 15-25:1 by weight composite in a mobile phase of 25% ethanol and 75% water. After drying, a yellow brown powder is obtained that contains 45 to 50% weight by weight (W/W) epigallocatechin gallate (EGCG) within a total of catechins in the powder at least about 75% W/W measured by HPLC. Unless specified otherwise, ratios, percents, and the like are expressed as mass, e.g., W/W. The extract is slowly added to the alcohol-water-muscadine juice mixture and mixed until no particles are visible.

A powdered extract of berries from the European elder tree (Sambucus nigra) is used. The extract contains a minimum of 0.03% W/W anthocyanidins. It is slowly added to the alcoholic-muscadine juice-green tea mixture until the desired color of the beverage is achieved

Leaves of the globe artichoke plant (Cynara Scolymus L.) are dried and extracted in an aqueous medium at 95% for 45 minutes to extract the active phytonutrients, cynarin and chlorogenic acid. The extract is concentrated under vacuum at about 150 millibars and at temperature around 50° C. The extract is then dried, and a brown bitter powder is obtained with 5% W/W cynarin measured by thin layer chromatography. The extract is added to the above beverage in quantity needed to create a slight spiciness to the final product. The preferred order of blending is the green tea extract, the artichoke extract, and finally the elderberry dehydrated juice extract to get the desired final color of the alcoholic beverage.

The final alcohol content of the composition was about 37.7% WV

The ratios of all ingredients are such that the pH remains below 4.65 to ensure that the EGCG and the other phytonutrients remain stable and carry the health benefits in the alcohol-based compositions.

### EGCG Stability in Alcoholic Beverage Compositions

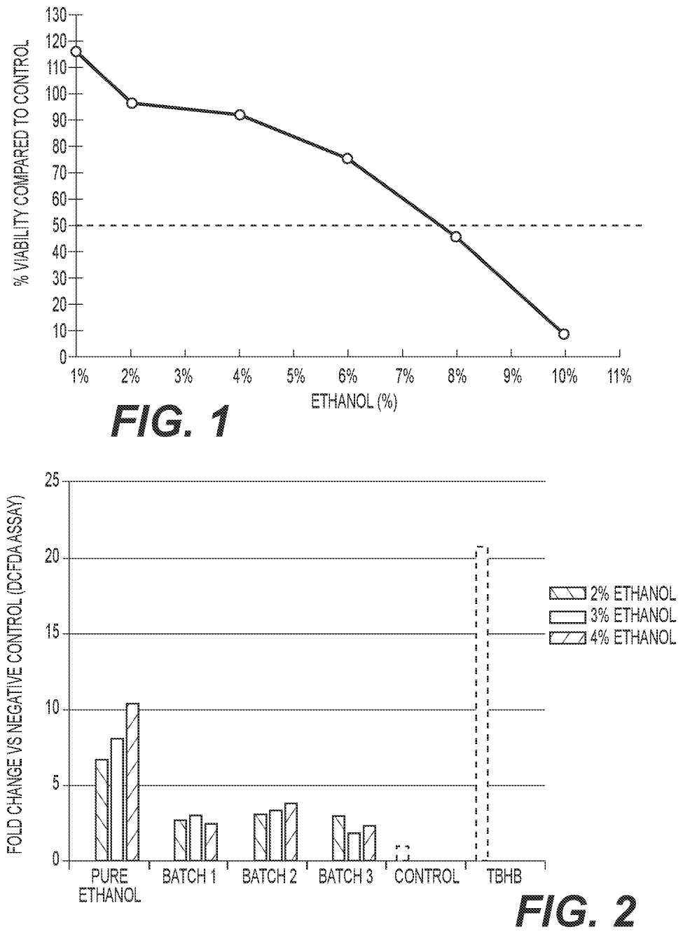

The composition confers stability to the phytonutrients that are key to flavor, taste and health benefits. One of the key phytonutrients is EGCG which was used as the marker to show its stability in the composition and how it goes through the intestinal membrane to bring benefits to the liver. In one embodiment the levels of EGCG were measured to show that EGCG is stable in this matrix before the composition was applied to the intestinal tissue and to the liver cells. Samples of botanical-infused alcoholic composition were prepared as follows. The samples were diluted to in deionized water to bring the alcohol concentration down to 8%. The experiment below showed the Maximum Tolerated Dose of Ethanol in a liver model using Fa2N-4 cells from Sekisui XenoTech by measuring ATP levels. Cells dosed with 100 μL of ethanol solutions and were incubated at 37° C. with 5% CO₂ for 24 hr. Intracellular ATP was expressed as % ATP vs. Vehicle Control. Data points represent mean±SEM of N=3 replicates. Maximum tolerated dose is determined to be the amount of ethanol that causes a 50% response in % ATP marked with the dotted reference line at 50% ATP (FIG. 1).

Beyond 8% ethanol, half the liver cells are killed as seen by a significant decrease in ATP production. It is important to create a condition where alcohol causes some damage and when applying the composition, a protective effect can be measured. The samples were also diluted to 6 and 2% alcohol.

The samples were tested by LC-MS/MS using a Waters Acquity UPLC system in-line with a Waters Xevo TO-S mass spectrometer via an electrospray interface. An EGCG powdered standard was purchased from Sigma-Aldrich. The EGCG standard was prepared as a 1 mg/mL solution in PBS containing 0.2% ascorbic acid and 0.005% EDTA to calculate the standard curve. EGCG was spiked into intestinal media at a 5% ratio of standard to media (% v/v). EGCG internal standard (IS) was prepared as a 200 ng/ml solution also using PBS containing 0.2% ascorbic acid and 0.005% EDTA. Ten μL of EGCG IS was added to 25 μL of EGCG standard, vortex mixed, and 2× extracted with 350 μL of ethyl acetate. Ethyl acetate extracts were dried in a SpeedVac concentrator at 40° C. for 20 minutes, then reconstituted with 100 μL of PBS containing 0.2% ascorbic acid and 0.005% EDTA. Samples of the alcoholic beverage composition were extracted and reconstituted in an identical manner as EGCG.

EGCG and samples of the alcoholic beverage composition were separated using a 1.0 mm×100 mm Waters HSS T3 column with 0.3% acetic acid/HO as mobile phase A and 0.3% acetic acid/acetonitrile as mobile. phase B. For gradient elution, initial B was 1%, increased to 95% Bat 2 minutes, 95% Bat 4 minutes, and back to 1% Bat 4.5 minutes. A flowrate of 0.2 ml/min was used, total run time was 6 minutes, and 5 μL of sample was injected. Data was analyzed using Waters Targetlynx application software and automatically exported as a CSV file for reporting.

EGCG was detected in the final alcoholic composition. These numbers are in line with the amounts of green tea leaf extract that was added to make this particular batch. Therefore this demonstrate that catechins and especially EGCG are stable in the novel composition

TABLE 1

| | Batch #1 |
|---|---|
| % Ethanol | EGCG {mg/ml) |
| 2% | 41.3925 |
| 6% | 121.1775 |
| 8% | 166.475 |

### Protection Against Oxidative Stress From Ethanol Exposure

The botanical-infused composition of the present invention is protective against oxidative damage to cells or tissues that have been stressed by ethanol.

### Example 1

Liver stress was measured by measuring the amount of reactive oxygen species (ROS) produced after exposure to the alcoholic composition. HepG2 liver cells were plated and grown overnight. Samples of the alcoholic composition (Test articles) were diluted to 2, 3, and 4% ethanol with deionized H₂O. Then the cells were exposed to the Test articles for 24 hours at 37° C. with 5% CO₂. Tert-butyl hydroperoxide (TBHP), used as the positive control and pure ethanol at concentration of 2, 3, and 4% were also applied to the liver cells for 24 hours at 37° C. with 5% CO₂. Amount of ROS was measured using the DCFDA/H2DCFDA Cellular ROS Assay Kit from Abeam.

Results are presented in FIG. 2.

Data are expressed as Fold Change vs. Negative Control. Bars represent mean±SEM of three replicate samples.

As displayed on FIG. 2 discussed above, the positive control produced a 22-fold increase in ROS versus the negative control. Pure ethanol also stressed the liver cells and produced a 6-to-10-fold increase in ROS. Three different batches of the invented composition protected the liver cells from oxidative damage as seen the lower bars compared to ethanol. The reduction in ROS production is 3 to 5 times compared to ethanol which is significant for reducing ROS damages to cells.

### Example 2

The invention is shown to protect against oxidative stress in intestinal tissue and/or liver tissues.

The human dynamic multiple organ plate (HuDMOP) developed by IONTOX (U.S. Pat. No. 9,631,167 B2) was used for testing. This plate is an accepted and unique state-of-the-art in vitro platform for evaluating drugs and chemicals. The FDA recognizes such in vitro models that provide comparative information of relative toxicity between an FDA approved compound and a new submission or in vitro data that focuses on mechanism. The HuDMOP system allows collection of intestinal absorption data, pharmacokinetic data, safety, and efficacy in a single model and can feature up to 6 organ compartments. Flow between the compartments is controlled through selection of dialysis membrane appropriate for the relevant organ systems, pressures, and membrane areas. The HuDMOP system is also used to generate data to support efficacy claims for botanicals.

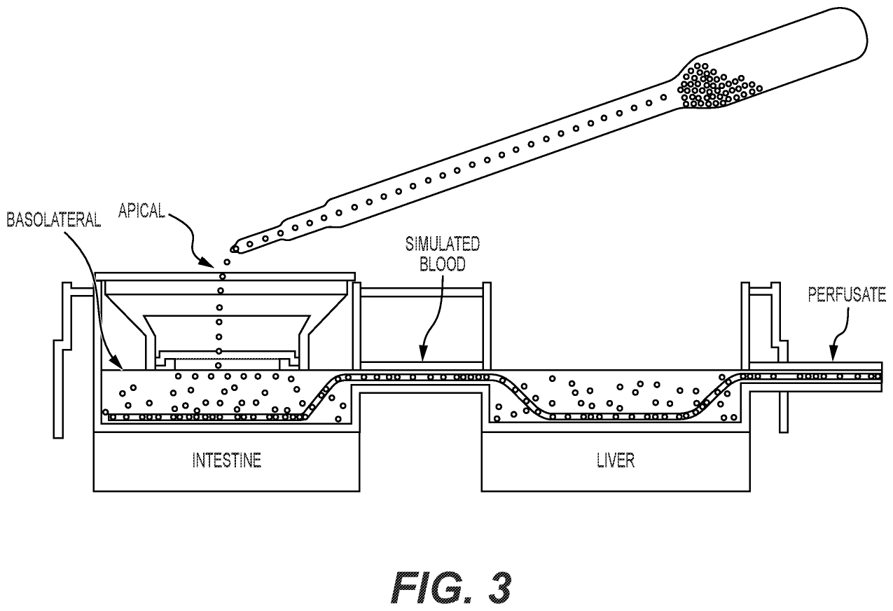

This example used a two-compartment test system for the kinetic experiments and gene expression as shown in FIG. 3. The model consisted of human 3D epidermal model (Epiltestinal tissue from MarTek) linked to HepG2 cells (Liver) linked by unidirectional simulated blood flow. Simulated blood consisted of saline with human serum albumin.

Diluted ethanol (EtOH) alone or a composition of the present invention diluted to the same level as the EtOH alone test are applied to the apical side of the intestine chamber at the start of the experiment. Composition batch 1 contains 9,703 ng/ml EGCG. The health of the intestinal tissue was measured with a MTT assay. Pure EGCG was also applied as a control. Tissues were dosed with 100 μL of the solutions and were incubated at 37° C. with 5% CO₂ for 24 hr. Cell viability was expressed at % viable vs. vehicle control. Data points represent mean±SEM of N=2 replicates.

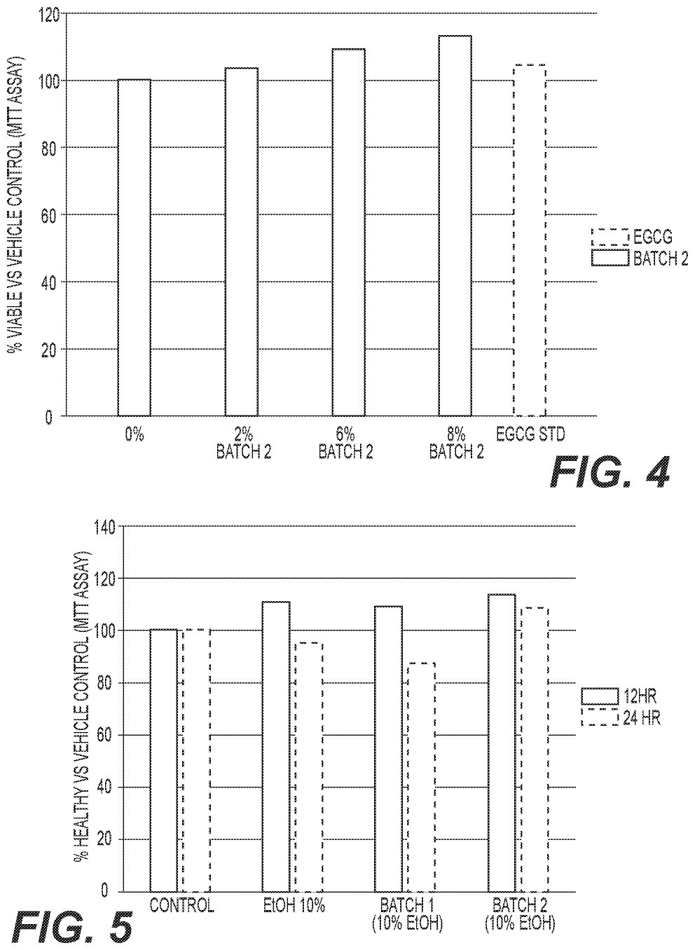

The health of the intestinal tissue was not affected by any of the conditions, whether it is ethanol, EGCG or the novel composition. (FIGS. 4 and 5).

### Example 3

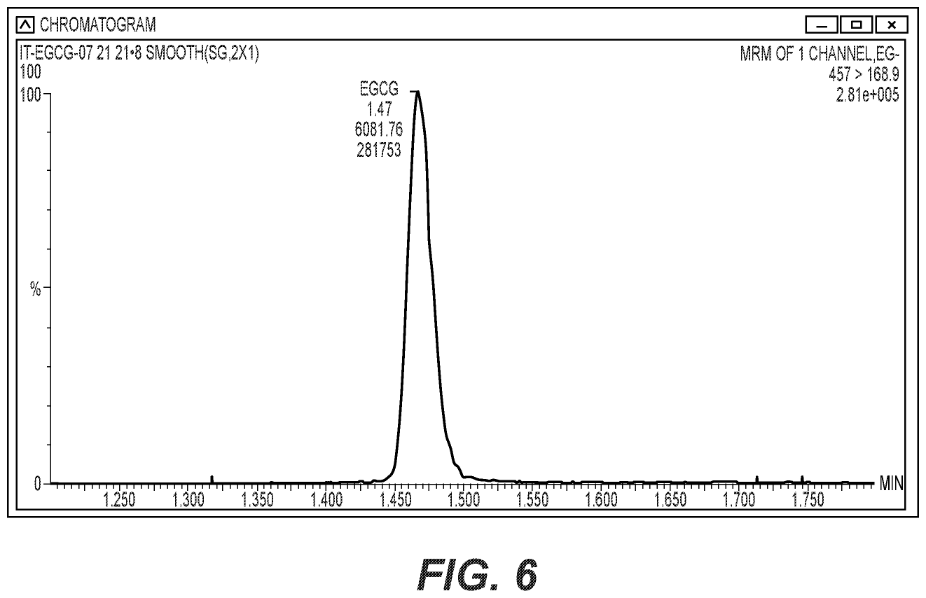

Samples were collected from the intestinal basolateral chamber (inferior chamber where fluid is collected after going through the intestinal tissue), liver chamber, and simulated blood perfusate at 0, 1, 2, 4, 6, 12, and 24 hr. Epigallocatechin gallate (EGCG) from the novel composition was used to track its intestinal permeability, its movement into simulated blood and delivery to the liver. EGCG content was measured by LC-MS/MS (FIG. 6).

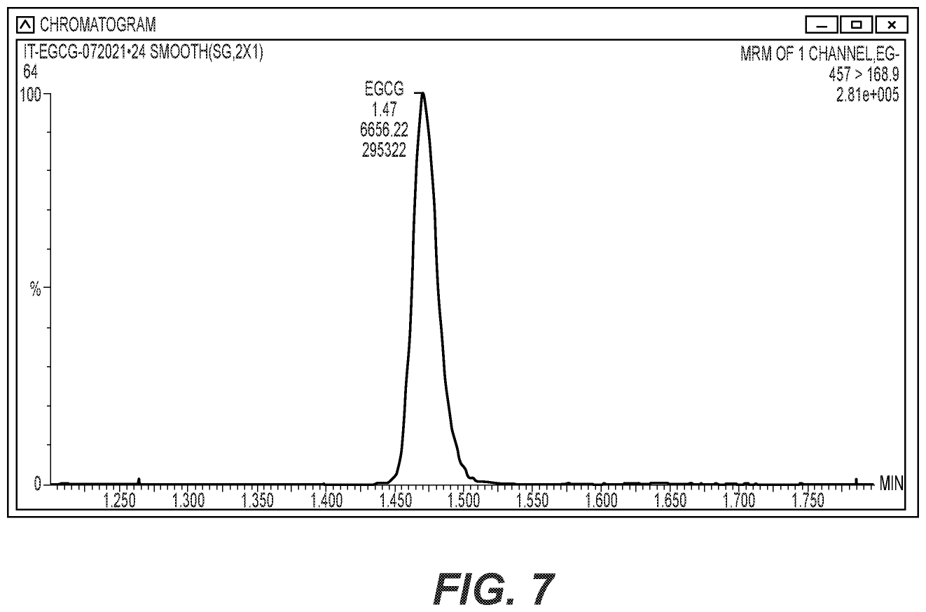

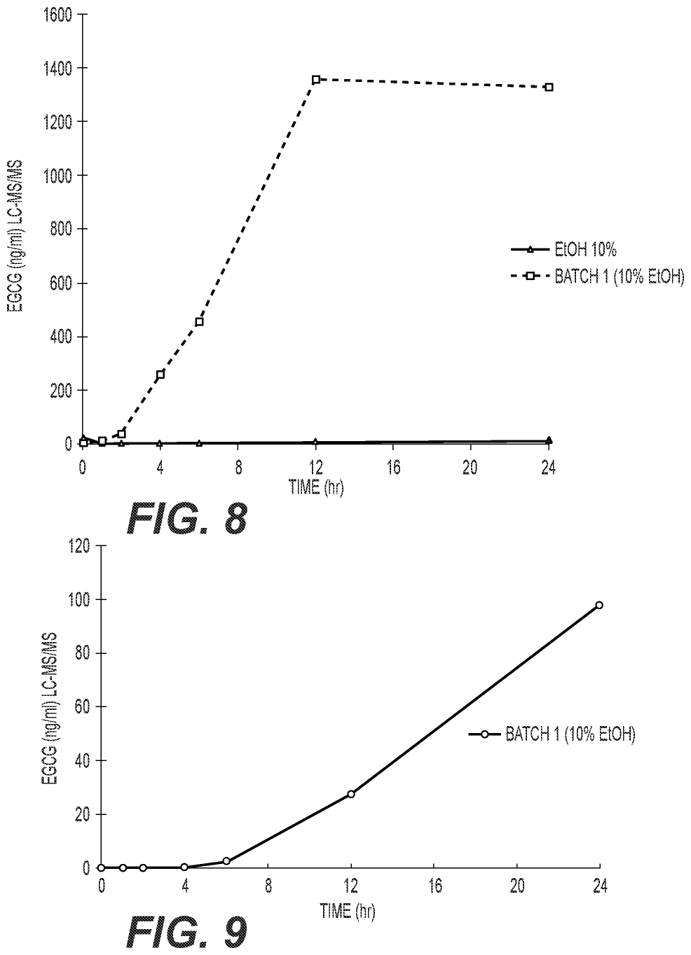

EGCG was detected in all the samples of composition batch 1. The data show that EGCG is able to go through the intestinal membrane and starts appear in the lower basolateral chamber 2 hours after application of the composition (FIG. 7). EGCG peak occurs at 12 hours with the amount being constant until 24 hours (FIG. 8). EGCG maximum concentration (Cmax) is about 1400 ng/ml. FIG. 9 shows that for batch 1 disposition of EGCG appears in the liver 6 hours after applying the composition to the intestinal tissue. FIG. 10 shows that EGCG remains in the perfusate after processing in the liver compartment.

### Example 4

Expression of genes important for protection from ROS.

Total RNA from the liver cells was obtained following the 12 and 24 hr time points post exposure to look at specific gene expression (NQO1, HMOX1, GSR) that are part of a group that protect the cell from oxidative stress and inflammation. An increase in fold change >2 is typically considered biologically relevant.

NADPH Quinone Dehydrogenase 1 (NQO1) protects cells by removing quinones from biological systems which prevents the formation of semiquinones and other reactive oxygen species which are known to be harmful to cells.

Heme oxygenase-1 (HMOX1) is an antioxidant protecting against oxidative stress, and it functions as an anti-inflammatory protein by upregulating anti-inflammatory cytokines such as IL-10 and reducing the expression of proinflammatory cytokines such as TNF-alpha.

Glutathione Reductase (GSR) catalyzes the reduction of GSSG to 2 molecules of glutathione (reduced GSH) the primary defense molecule of oxidative stress. The ability of the body to help regenerate glutathione in its reduced form would significantly help reduce oxidative stress.

RNA was extracted from liver cells using the RNeasy Mini kit along with Proteinase Kand DNase I digestion to remove proteins and gDNA. DNase I was purchased from Qiagen. Total RNA was quantified using the NanoDrop 2000. The RNA obtained was used to measure the expression of the above target genes by RT-qPCR. 10.10. TaqMan* fast virus 1-step master mix (Thermo Fisher) was used. One-Step RT-qPCR was performed using the QuantStudio 5 PCR Instrument from Thermo Fisher and by following the manufacturer's recommended cycling protocol. All primer/probe sets were obtained from Thermo Fisher.

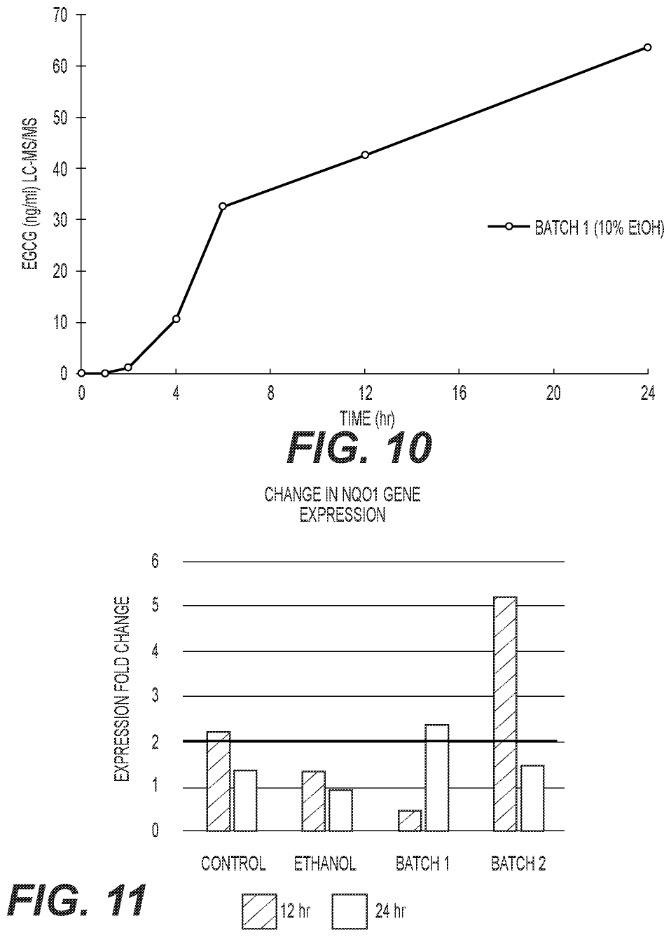

FIG. 11 shows no increase in NQO1 gene expression from EtOH exposure. Batches of the present invention resulted in at least a 2 fold increase, a relevant increase, in expression of the anti-oxidative protective gene, NQO1.

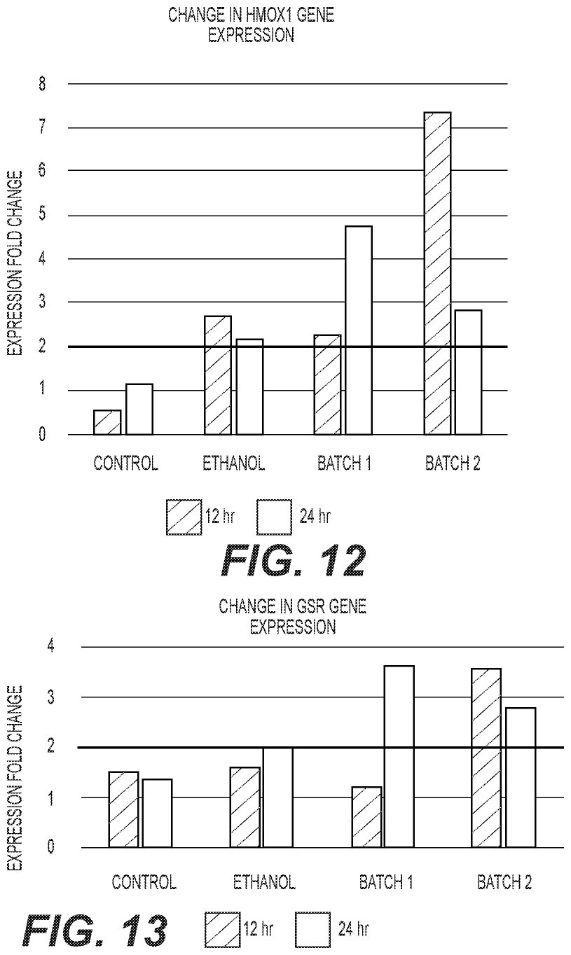

FIG. 12 shows that EtOH induces an increase in HMOX1 expression. However, batches of the present invention increase the expression of HMOX1 significantly more fold, thus more robustly protecting the cells from oxidative stress. FIG. 13 shows that ethanol does not produce an increase in the expression of GSR gene whereas, the novel composition increases the expression of GSR, while batches of the present invention result in a highly relevant >3½-fold increase in expression of this important anti-oxidation gene.

The evidence clearly shows that a botanical-infused alcoholic composition of the present invention is stable overtime and features measurable amounts of a recognized phytonutrient (EGCG) permeated the intestinal tissue and acts as a protectant delivered to and available for metabolic activity in the liver. In addition, the composition provides protection to the liver from ethanol-induced oxidative toxicities. LC-MS/MS results demonstrated that ECGC was delivered to the liver after permeating the intestine. In addition, EGCG produced no cytotoxic effect and the botanical infused vodka samples showed protection from ethanol-induced liver stress. Reduction of ethanol induced oxidative stresses may be accomplished by direct action of antioxidants and/or by induced action of protective genes. The composition increased the expression of protective genes (NQO1, HMOX1 and GSR) in the liver further confirming valuable health benefits that would not be expected upon consumption of non-infused alcoholic beverage.

1. A catechin stabilizing alcoholic beverage comprising:
a) a mixture comprising approximately 40% by volume ethanol in water;
b) white muscadine juice; and
c) green tea extract;
said beverage comprising about: 7 to 9 parts a), 0.5 to 1.5 parts b), and 0.05 to 0.5 parts c) by weight.

2. The beverage of claim 1 further comprising about 0.01 to 0.2 parts by weight elderberry powdered extract.

3. The beverage of claim 1 further comprising about 0.001 to 0.05 parts by weight artichoke leaf extract powder.

4. The beverage of claim 3 wherein said artichoke leaf extract comprises about 5% cynarin measured by thin layer chromatography.

5. The beverage of claim 1 with a capacity to increase NADPH Quinone Dehydrogenase 1 (NQO1) gene expression by a factor of greater than 2 fold in 2 compartment HuDMOP liver perfusate following application to and transport through intestinal tissue.

6. The beverage of claim 1 with a capacity to increase Glutathione Reductase (GSR) gene expression by a factor of greater than 2 fold in 2 compartment HuDMOP liver perfusate following application to and transport through intestinal tissue.

7. The beverage of claim 1 with a capacity to increase Glutathione Reductase gene expression by a factor of greater than 4 fold measured at ^{˜}12 hours or ^{˜}24 hours in 2 compartment HuDMOP liver perfusate following application to and transport through intestinal tissue.

8. The beverage of claim 1 with a capacity to increase Heme oxygenase-1 (HMOX1)gene expression by a factor of greater than 2 fold in 2 compartment HuDMOP liver perfusate following application to and transport through intestinal tissue.

9. The beverage of claim 1 with a capacity to increase Heme oxygenase-1 gene expression by a factor of greater than 4 fold measured at ^{˜}12 hours or ^{˜}24 hours in 2 compartment HuDMOP liver perfusate following application to and transport through intestinal tissue.

10. The beverage of claim 1, wherein said green tea extract is obtained from Camellia sinensis.

11. The beverage of claim 2, wherein said elderberry extract is obtained from Sambucus nigra.

12. The beverage of claim 2, wherein said elderberry extract contains at least 0.03% anthocyanidins.

13. The beverage of claim 3, wherein said artichoke powder is obtained from Cynara Scolymus L.

14. The beverage of claim 1 further comprising about 0.01 to 0.2 parts by weight elderberry powder and about 0.001 to 0.05 parts by weight artichoke leaf extract powder.

15. The beverage of claim 14 wherein said green tea extract is added prior to said artichoke extract powder, and said elderberry extract powder is added following said addition of said extract powder.

16. The beverage of claim 15 having a pH less than 4.65.

17. A composition comprising a) ethanol in water, wherein said ethanol content is about 40% by volume and b) muscadine juice having a sugar level between 12-13.5% Brix and a pH in a range between ^{˜}3 and ^{˜}4.

18. The composition of claim 17 wherein said pH is less than about 4.65.
